(19) United States
(12) Patent Application Publication
(10) Pub. No.: US 2013/0243143 A1
(43) Pub. Date: Sep. 19, 2013

(54) REACTOR FOR ENERGY GENERATION THROUGH LOW ENERGY NUCLEAR REACTIONS (LENR) BETWEEN HYDROGEN AND TRANSITION METALS AND RELATED METHOD OF ENERGY GENERATION

(71) Applicant: STMICROELECTRONICS S.R.L., Agrate Brianza (IT)

(72) Inventors: Ubaldo MASTROMATTEO, BAREGGIO (IT); Federico Giovanni ZIGLIOLI, POZZO D'ADDA (IT)

(73) Assignee: STMICROELECTRONICS S.R.L., Agrate Brianza (IT)

(21) Appl. No.: 13/775,444

(22) Filed: Feb. 25, 2013

(30) Foreign Application Priority Data
Feb. 24, 2012 (IT) MI2012A000276

(51) Int. Cl. G21B 3/00

(52) U.S. Cl. CPC G21B 3/002
USPC 376/148

(57) ABSTRACT

An embodiment of an apparatus includes a reaction chamber, a reaction unit, and an energy regulator. The reaction chamber includes an energy port, and the reaction unit is disposed in the reaction chamber and is configured to allow an energy-releasing reaction between first and second materials. And the energy regulator is configured to control a rate at which reaction-released energy exits the reaction chamber via the energy port. The reaction chamber may include a thermally conductive wall that forms a portion of the energy port, and the energy regulator may include a thermally conductive member and a mechanism configured to control a distance between the thermally conductive wall and the thermally conductive member. Furthermore, the reaction unit may include a mechanism configured to facilitate the reaction between the first and second materials, and may also include a mechanism configured to control a rate at which the reaction releases energy.

### PRIORITY CLAIM

The instant application claims priority to Italian Patent Application No.MI2012A000276, filed Feb. 24, 2012, which application is incorporated herein by reference in its entirety.

### TECHNICAL FIELD

An embodiment relates to the field of the energy manufacture through nuclear reactions activated by interaction between hydrogen and transition metals.

In particular, an embodiment relates to a reactor for the generation of energy through LENR reactions (Low Energy Nuclear Reactions) conducted on surface layers of transition metals whereon isotopes of hydrogen are made to adsorb.

Moreover, an embodiment relates to a method for the generation of energy that uses a reactor of the above-mentioned type.

### SUMMARY

As it is well known, the supplying of energy constitutes an ever more important problem due to the ever decreasing availability of fossil fuels (mainly oil) and to the environmental pollution that derives from their use.

It is thus desirable to find energy sources that are non-polluting, non-dangerous for health, economically competitive with the fossil fuels (oil) and that can be easily found and are abundant in nature.

During the recent decades, several energy sources alternative to oil have been explored, tested, and sometimes used on an industrial scale for replacing, or at least for using alongside, fossil fuels.

An energy source alternative to fossil fuels that is still an object of study is constituted by the energy produced by nuclear reactions that are activated on the surface of transition metals whereon hydrogen or its isotopes are made to adsorb. This phenomenon is known in the scientific environment with the acronym LENRs (Low Energy Nuclear Reactions) since all the experimental data lead to conclude that the amount of energy developed cannot but derive from interactions at the nuclear level between the hydrogen or its isotopes and the metal. It is also known, in the scientific environment, that this phenomenology can constitute in principle a particularly advantageous energy source both in terms of ease of finding and abundance of the fuel and in terms of greater safety of use (for example with respect to nuclear fission) and of reduced environmental impact.

The first studies on cold nuclear fusion, as such, are ascribed to Fleischmann and Pons and were disclosed in 1989 (M. Fleischmann, S. J. Pons, Journal of Electroanal. Chem. 261, 301 (1989)), which is incorporated by reference. An international patent application (WO 90/10935), which is also incorporated by reference, has also been filed by these two research scientists.

The phenomenon considered by them is the charging of deuterium by palladium or titanium electrodes. During this charging, an unexpected generation of thermal energy is found that is ascribed to a nuclear fusion reaction between the deuterium atoms for forming helium.

Subsequent tests have shown that by storing hydrogen or its isotopes in the crystal lattice of some metals that belong to the group of the transition metals, it is possible, under certain conditions, to obtain an anomalous production of thermal energy when the concentration of hydrogen or its isotopes exceeds the typical thermodynamic equilibrium values.

The results of these tests have converged into the realization of some methods and reactors for the production of energy through LENR reactions of hydrogen isotopes, which are described, for example, in patent applications WO 95/20816 and WO 2010/058288, which are incorporated by reference.

In spite of the efforts made to date, the realization of a reactor in which the LENR reactions can be implemented in a repetitive and reliable way, and with a capacity of producing energy in an efficient way for the current uses (for example of the civil, industrial, or domestic type), still meets remarkable obstacles of a technical nature. These obstacles mostly derive from the difficulty of controlling, in an adequate way, the parameters that determine the nuclear reaction which implies, inter alia, also a reduced efficiency of the process of energy production.

Application WO 01/29844, which is incorporated by reference, describes a method and a related apparatus for generating thermal energy through a low-temperature nuclear reaction, and proposes, moreover, the monitoring of the nuclear-reaction temperature by means of a temperature sensor coupled to a control module, which acts in feedback on the intensity and on the frequency of current pulses applied to the reactive material for triggering the exoenergetic reactions. This monitoring is executed with the primary aim of regulating the generation of energy by maintaining a substantially constant reaction temperature.

Although the above-mentioned system of control and modulation of the nuclear reaction is, in principle, satisfactory, it may be helpful to improve the modulation and the control of the nuclear reactions so as to obtain an adequate efficiency of generation and of retrieval of energy for each application, for example, of civil and/or industrial use, and accomplishing all of the above in a simple and low-cost way.

An embodiment is an apparatus and related method for the generation of energy through low-temperature nuclear reactions that have such structural and functional characteristics as to allow a better control and modulation of the nuclear reaction as compared to prior techniques, as well as an improvement of the efficiency of generation and retrieval of the energy, according to the application.

Another embodiment is an apparatus and related method as above that involve costs of realization and implementation that are acceptable for a civil and/or industrial use.

An embodiment is an apparatus for the generation of energy through low-temperature nuclear reactions including a reactor for the execution of such nuclear reactions, the reactor having:
a chamber of energy generation containing an active material able to adsorb hydrogen and/or its isotopes, said active material constituting the site for the execution of said nuclear reactions,
means for the heating of said active material arranged in said generation chamber,
triggering means of said nuclear reactions,
at least one temperature sensor arranged in said chamber of energy generation for monitoring the reaction temperature,
the apparatus also including a control module for modulating the application of said triggering means according to the temperature detected by said at least one temperature sensor and further including
an external chamber that encloses the chamber of energy generation, the external chamber having at least one wall portion realized in a high-thermal-conductivity material and faced towards at least one wall portion of the generation chamber, the latter also realized in a high-thermal-conductivity material,
handling means for moving said external chamber and/or said generation chamber between a first position in which the at least one wall portion of high-thermal-conductivity material of said chamber of generation and the at least one wall portion of high-thermal-conductivity material of said external chamber are substantially in contact with each other and a second portion in which said at least one wall portion of high-thermal-conductivity material of said generation chamber and said at least one wall portion of high-thermal-conductivity-material of said external chamber are in mutual maximum distancing away from each other,
optionally, means for applying a reduced pressure in the gap between said generation chamber and said external chamber.

According to an embodiment, the above handling means may be coupled to said external chamber, may move the external chamber with respect to the generation chamber between said first position and said second position, and may be in communication with said control module, and may be thereby controlled according to the reaction temperature measured by said temperature sensor.

In this way, it has been found that it may be possible to modulate in an efficient way and according to a specific application the amount of thermal energy produced in the generation chamber and exiting the reactor towards a suitable system of retrieval of the thermal energy for its possible conversion, for example, into electric energy. In particular, in the position of distancing away between the at least one highly thermoconductive wall portion of the generation chamber and of the external chamber a gap is created, possibly under vacuum, and thus having very low thermal conductivity that reduces the flow of thermal energy exiting the reactor towards the system of retrieval and possible conversion of the thermal energy. Vice versa, in the contact position between the at least one highly conductive wall portion of the generation chamber and of the external chamber an optimal (maximum) capacity of the flow of thermal energy exiting the reactor towards the system of retrieval and possible conversion of the thermal energy is ensured.

Taking into account that the energy produced in the LENR nuclear reactions by means of the above active material and of the hydrogen and/or its isotopes adsorbed thereon is usually very abundant and concentrated, the above technique of handling of the chambers also allows a significant reduction in the sizes of the reactors, in particular, if the reactors are designed to generate a relatively small amount of power.

The active material may be placed near to or in contact with the at least one highly thermoconductive wall portion of the generation chamber, i.e., at a distance, for example, approximately between 0 millimeters (mm) and 10 mm. This may favors the conveying of the thermal energy produced in the generation chamber towards the facing and highly thermoconductive areas of the generation chamber and of the external chamber reducing at the same time the possible heat dispersions through walls or wall portions having lower thermal conductivity of the generation chamber and of the external chamber.

The heat dispersions may be further reduced by producing a vacuum by the above means in the gap between the generation chamber and the external chamber.

According to an embodiment, the above temperature sensor and the above heating means are both formed or integrated on an inert support. Moreover, the reactor further includes second handling means coupled to the inert support for regulating the position of the inert support between a first operative position of minimum distancing from said active material and a second operative position of maximum distancing from said active material, said distancing being, for example, approximately between 0.1 mm (minimum) and 10 mm (maximum).

In this way, it may be possible to advantageously regulate the volume of gas (hydrogen and/or its isotopes) that is near or at the active reaction area, where the most active hydrogen atoms for the nuclear reaction (H-ions) are found, originating from the surface of the active material, that, in this way, are more or less confined for the purpose of intensifying or depressing the entity of the reaction itself. For example, these second handling means are in communication with the control module and may be regulated by the latter according to the reaction temperature detected by the at least one temperature sensor so as to advantageously operate a further control and modulation on the nuclear reaction.

By the term “inert support,” what is meant is a non-reactive support provided with adequate resistance under the conditions of the nuclear reactions, in particular at temperatures approximately between 100° C. and 500° C. This may be attained by realizing the support with materials per se endowed with these characteristics or by using materials that do not have the above characteristics per se but which are are suitably treated so as to be substantially “inert” in the sense intended by an embodiment of the present disclosre.

According to an embodiment, the support consists of a substrate in semiconductor material, in particular silicon coated with a layer of (thermal) silicon oxide on the surface of which said heating means and said at least one temperature sensor are formed or integrated, so as to make the substrate inert under the conditions of the nuclear reaction and electrically separate the heating means and the at least one temperature sensor formed on the support by the silicon underlying the oxide.

Alternatively, the inert support may be realized in a ceramic material such as sintered allumina.

The inert support, for example a silicon substrate coated with a superficial oxide layer, may be in the shape of a die, whereon said at least one temperature sensor and said heating means are superficially integrated or formed, on the oxide layer. The above die has a generally reduced thickness, for example, approximately between 0.2 mm and 0.8 mm.

Advantageously, said at least one sensor and said heating means may be integrated on said support in the form of a thin layer of a suitable material having such properties as to simultaneously serve as heater and temperature sensor.

Materials suitable for this purpose are in particular metals such as nikel and platinum that are able to generate heat when crossed by electric current through the Joule effect and also have resistivity properties being variable when the temperatures vary according to a substantially linear relation. The determination of the temperature may thus be made by measuring the resistance of the metal and by comparing this resistance with a reference (resistance variation per temperature unit) previously determined during the calibration step. The formation of the thin layer having the simultaneous function of sensor and heater on the inert support may be advantageously executed by means of the normal techniques of current use for microelectronics or for the MEMS that involve the deposition of metals by several techniques, in particular sputtering, spraying, chemical vapor deposition, or epitaxial deposition.

The thickness of the thin layer constituting the temperature sensor and the heating means may be, for example, approximately between 50 nm and 1000 nm.

Thanks to the technologies currently in use in microelectronics and MEMS, it may be possibile to simultaneously realize, on an inert support, for example a silicon substrate coated with a layer of the respective oxide, heaters and temperature sensors suitable for being used in reaction chambers where the interaction between hydrogen and transition metals for the activation of nuclear reactions occurs at temperatures approximately between 100 and 500 degrees Celsius (° C.). This realization may be attained with relatively reduced costs and in a compact, extremely precise form.

These technologies may include, in particular, deposition techniques and photolithographic techniques currently in use in microelectronics and for MEMS devices. The deposition techniques, such as, for example, sputtering and CVD (Chemical Vapor Deposition), allow the deposition of metals of various type on various materials, mainly semiconductors, for example, to form heaters and resistors, in the form of very thin layer, also of nanometric sizes, having a thickness controlled in a very precise way, thus obtaining a savings in the amount of metal used. This saving turns out to be relevant especially in a large scale production, considering the generally high costs of the suitable metals that can be used, and, in particular, the high costs of some of them (for example, platinum). With the photolitographic techniques, it may be instead possible to define the geometry on the plane of the thin metal layers deposited in a very precise way.

The above technologies, moreover, may advantageously allow obtaining from a single substrate, for example, in silicon, a remarkable plurality of supports functionalized with heaters and sensors in an easy and considerably precise way.

Moreover, thanks to the use of an inert support such as a silicon substrate coated with oxide, per se very resistant to temperature, it may be possible to arrange the temperature sensors and the heating elements near the active material and, therefore, near the area where the nuclear reactions take place, without causing cracks or significant damage.

In particular, according to an embodiment, the inert support, for example a silicon substrate coated with oxide on the surface having the heating elements and the temperature sensors, may be arranged near the active material with the heating elements and the temperature sensors faced towards the active material.

Alternatively, the inert support may be provided with a cavity for containing the active material (for example powders of the active material). Advantageously, such cavity may be electrically insulated, for example, through coating of the same with a silicon oxide layer in case of use of silicon substrate as a support.

This may advantageously allow a better control of the procedure of generation of the energy, in particular, as regards the detection of the reaction temperature, the efficiency of the heating of the active material, and the modulation of the reaction parameters by means of the control module according to the reaction temperature detected by the temperature sensor.

This modulation may relate, in particular, to the operability of the triggering means (for example intensity and frequency) for maintaining a substantially constant reaction temperature (and consequently an energy-production power being substantially constant as well) or for obtaining a greater or lower regulation of the amplification of the energy according to specific applications.

According to an embodiment, the reactor includes an upper inert support and a lower inert support between which the active material is interposed, each of said lower and upper supports having at least one temperature sensor and heating means formed or integrated on a respective surface faced towards the active material. One of the above supports, for example the upper support, may be mobile between said a first operative position of proximity (or maximum approaching) with said active material and said second operative position of maximum distancing from said active material, this by means of said first handling means, so as to regulate the volume overlying the active material.

In the reactor according to an embodiment, the active material includes a metallic material able to adsorb hydrogen (and its isotopes) in a sufficiently high amount for the triggering of nuclear reactions under predetermined operative conditions per se known.

Suitable metallic materials belong to the group of the transition metals and may be chosen from the group including: Sc, Ti, V, Cr, Mn, Fe, Co, Ni, Zn, Y, Zr, Nb, Mo, Tc, Ru, Rh, Ag, Cd, Lu, Hf, Ta, W, Re, Os, Ir, Pt, Au, lantanoids, actinides, and an alloy between two or more of the listed metals.

The metallic material may be chosen from the group including nickel (Ni), palladium (Pd), platinum (Pt), tungsten (W), titanium (Ti), iron (Fe), cobalt (Co) and alloys between two or more of such transition metals.

In an embodiment, the transition metals used, or their alloys, have a surface crystalline structure, for example, with crystalline clusters having micro and/or nanometric sizes, so as to ensure the adsorption of a high amount of hydrogen and the capture of possible ionic species that can be strongly attracted in a deep-energetic fashion, and even interact with the nuclei of the metal.

The metallic material may be in contact with a support, or interposed between two supports, and may have any shape, for example, it may be in the shape of sheets, bars, dies, or the like, or in the form of powders.

The coupling of the metallic material with the support (or the supports) may be executed in different ways according to the type of the support and of the metallic material used, and may include, in particular, one of the following steps:
arranging at least one layer of powder of a metallic material in a cavity of a support, said powder including crystalline clusters of micro and/or nanometric sizes,
arranging a metallic die on the support or between a pair of supports, said die having smaller sizes than those of the support (or of the supports) and being optionally coated on the surface exposed to the hydrogen with the at least one layer of a metallic material containing crystalline clusters of micro and/or nanometric sizes, for example, by means of deposition techniques.

The arrangement of powders of the metallic material in the cavity of the substrate may have the advantage of offering a larger surface for the adsorption of hydrogen, thus favouring the nuclear reaction.

The formation of the at least one sensor and of the heating means on the support/s in the form of thin layers may be executed by means of conventional deposition techniques commonly used in microelectronics among which, by way of non-limiting indication, the following ones are mentioned:
sputtering,
spraying,
deposition of metal vapors, i.e., a procedure including the evaporation and the subsequent condensation on the substrate of a predetermined amount of the metallic material,
epitaxial deposition.

The apparatus according to an embodiment, moreover, includes suitable means for the supply of hydrogen and/or its isotopes or for the supply of other compounds able to free hydrogen and/or its isotopes in the generation chamber.

The above supply may be executed by using natural hydrogen, i.e., hydrogen containing deuterium with an abundance of isotopes substantially equal to approximately 0.015%, or hydrogen with a different content of deuterium.

In the reactor according to an embodiment, the means for triggering the low-temperature nuclear reaction are, for example, chosen from the group including:
means for creating a thermal shock in the active material, in particular by means of the hydrogen flow, maintained at a predetermined temperature lower than the temperature of the reactive material;
means for impulsively applying a packet of electromagnetic fields, in particular, chosen among a radiofrequency pulse of a frequency higher than approximately 1 kHz;
means for creating a pulsive electric current through an electrostrictive portion of said reactive material;
means for impulsively applying a beam of elemental particles, in particular electrons;
means for applying an impulsive magnetic field along said reactive material having a magnetostrictive portion,
and their combinations.

Advantageously, the triggering means may be in communication with the control module and may be controlled by the latter for modulating the nuclear reactions and the consequent generation of energy. For example, the triggering means may be modulated by the control module for frequency and intensity according to the reaction temperature measured by the sensor for maintaining a substantially constant reaction temperature or for increasing or decreasing the amplification of generation of the energy produced according to the application.

The reactor according to an emodiment may further include means for creating at the active material a field chosen among:
a magnetic induction field of intensity ranging approximately between 1 Gauss and 70000 Gauss;
an electric field of intensity ranging approximately between 1 V/m and 300,000 V/m.

In this way the passage and the stationing of ions H- on the active material and the maintainance of conditions suitable for the prosecution of the nuclear reactions triggered by the triggering means may be favored. Advantageously, these means may be in communication with the control module and modulated by the latter in a similar way with respect to what has been described above for the triggering means.

An embodiment also relates to a method for the generation of energy that uses an apparatus of the above type. In particular, an embodiment of a method includes the steps of:
arranging an active material able to adsorb hydrogen and/or its isotopes for the execution of low-temperature nuclear reactions in said chamber of energy generation,
heating said active material by means of said heating means until a predetermined temperature has been exceeded, functional to the adsorption of hydrogen on said material in such concentration as to allow the activation of nuclear reactions,
triggering said nuclear reactions by means of said triggering means,
monitoring the reaction temperature by means of said at least one temperature sensor,
modulating at least said triggering means by means of said control module according to the temperature detected by said temperature sensor,
regulating the mutual distance between the at least one high-thermal-conductivity wall portion of the external chamber and the at least one high-thermal-conductivity wall portion of the generation chamber between a first position in which said at least one high-thermal-conductivity wall portion of said generation chamber and said at least one high-thermal-conductivity wall portion of said external chamber are substantially in contact with each other and a second portion in which said at least one high-thermal-conductivity wall portion of said generation chamber and said at least one high-thermal-conductivity wall portion of said external chamber are in mutual maximum distancing away from each other,
possibly applying a reduced pressure, in the gap between said generation chamber and said external chamber.

The mutual distance between the at least one high-thermal-conductivity wall portion of the external chamber and the at least one high-thermal-conductivity wall portion of the generation chamber may be regulated according to the reaction temperature measured by said temperature sensor.

According to an embodiment, the modulation of the triggering means is executed so as to maintain a substantially constant reaction temperature or for increasing or decreasing the amplification of generation of the energy produced.

According to another embodiment, the above at least one temperature sensor and the above heating means are integrated together on an inert substrate, and the method further includes the step of regulating the position of said inert substrate between a first position of minimum distancing from the active material and a second operative position of maximum distancing from the active material (9). This distancing may beapproximately between 0.1 mm (minimum) and 10 mm (maximum).

### BRIEF DESCRIPTION OF THE DRAWINGS

Further characteristics and advantages of an apparatus and of a method for the generation of thermal energy will be more apparent from the following description of one or more embodiments given by way of indicative and non-limiting example.

FIG. 1 schematically shows, in lateral section, an apparatus or reactor for the generation of energy according to an embodiment.

FIG. 2 schematically shows, in lateral section, a detail of the reactor of FIG. 1 from an angle staggered by 90° with respect to that of the view of FIG. 1, according to an embodiment.

FIG. 3 shows a control module and its interactions with the other components of the apparatus shown in FIG. 1, according to an embodiment.

FIG. 4 shows an exploded detail relating to a pair of supports each one having a heater and temperature sensor realized according to an embodiment and that can be used in the apparatus shown in FIG. 1.

### DETAILED DESCRIPTION

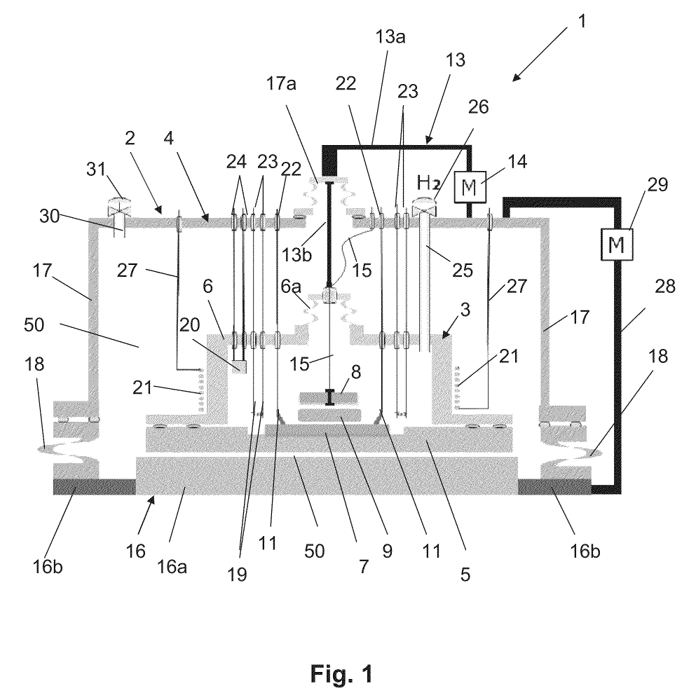

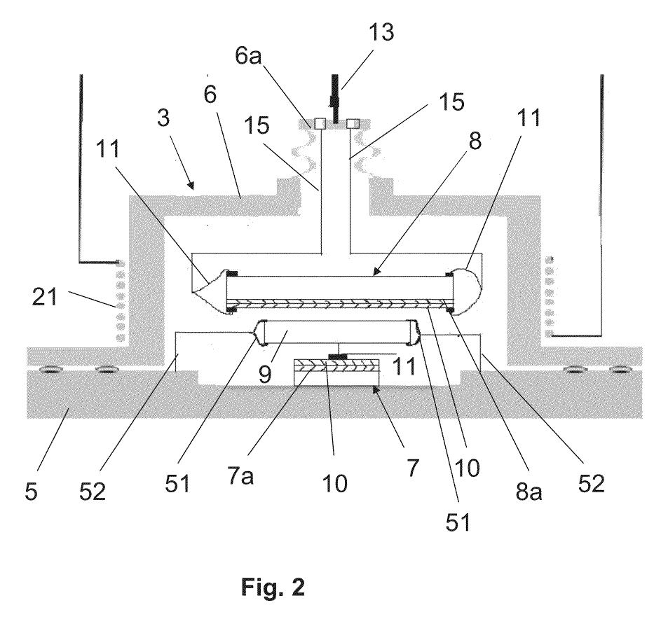

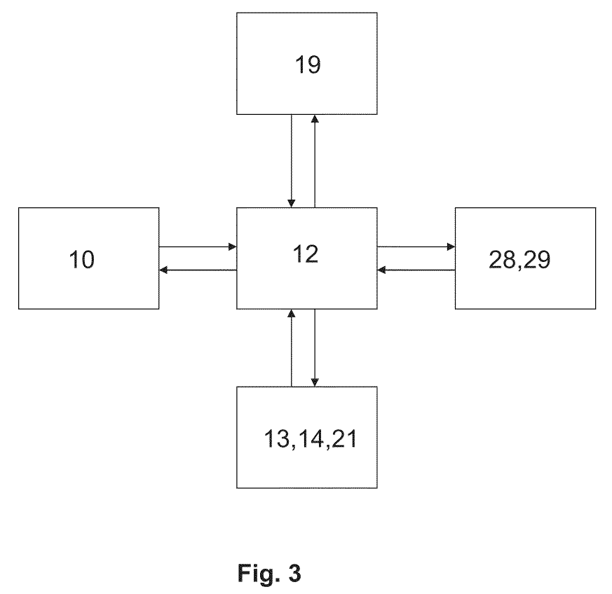

With reference to FIGS. 1-3, an apparatus for the generation of energy according to an embodiment is globally indicated with reference number 1.

The apparatus 1 includes a reactor 2 wherein a nuclear reaction takes place according to an embodiment.

The reactor 2 includes an internal chamber 3, also called a generation chamber, and an external chamber 4 that substantially encloses the internal chamber 3.

The generation chamber 3 is delimited on the bottom by a lower wall or die 5 and on the top by a bell 6 tight-seal coupled to the lower wall 5 along an end peripheral portion of the latter. The bell 6 has a top portion 6a realized in flexible material, i.e., elastically deformable, for example, a wavy, flexible plate.

The generation chamber 3 may be realized in metallic material resistant to temperatures up to at least approximately 500° C. with the material forming the lower wall 5 that exhibits, moreover, better thermal conductivity characteristics compared to the material forming the bell 6.

Metallic materials suitable for the lower wall 5 are, for example, copper, aluminium, etc. while a metallic material suitable for the bell 6 is, for example, steel.

The external chamber 4 is delimited on the bottom by a lower wall 16 and on the top by a bell 17 tight-seal coupled to the lower wall 16 along an end peripheral portion of the latter with interposition in said end portion of a peripheral ring 18 realized in a flexible material, i.e., elastically deformable, for example, a ring of a wavy metal. The bell 17 exhibits, in turn, a top portion 17a realized in flexible material, i.e., elastically deformable, for example, a wavy, flexible plate. Such top portion 17a of the external chamber 4 is substantially axially aligned to the top portion 6a of the internal chamber 3.

The internal chamber 3 contains a pair of supports, specifically a lower die 7 and an upper die 8, including an inert material or a material made inert on its surface, in particular, silicon superficially coated with a layer 7a or 8a of silicon oxide.

The dies 7 and 8 are arranged perpendicularly with respect to each other so that they can be electrically coupled in an easier way from the outside of the reactor 2 and on each of them a thin layer 10 of a suitable metal is formed, in particular, nickel or platinum, having simultaneous functions of heater and temperature sensor. The dies 7 and 8 are suitably provided with electric couplings (in particular terminals 11 and couplings (through) cables 15 and 22 better described hereafter) for the electric coupling of the respective thin metallic layers 10, each having functions of heater and temperature sensor, to a control module 12 external with respect to the reactor 2 (for example, the control module may be, or may include, a conventional microcontroller or microprocessor). Such electric couplings thus cross the generation chamber 3 and the external chamber 4 and are electrically coupled to the control module 12. The formation of the thin layer may be executed by means of technologies commonly in use in microelectronics and for the realization of MEMS that ensure a large-scale production at low cost and a great precision in the realization of the functionalized dies with heater and temperature sensor.

These technologies substantially include deposition techniques of various type, as previously cited, that allow the surface deposition on support in silicon/silicon oxide of thin metal layers, also of nanometric sizes and photolitographic techniques for determining the geometric shape desired for the heaters and temperature sensors.

For example, it may be possibile to realize by means of sputtering techniques one thin layer of platinum having a thickness of about 250 nm and resistance variation per temperature unit characteristics as determined during the calibration step of about 0.05 ohm/° C.

Between the dies 7 and 8 an active material 9 is interposed, i.e., a metallic material as previously defined (including one or more transition metals or their alloys) able to adsorb hydrogen and/or its isotopes in great amounts and whereon nuclear reactions may be triggered and maintained under predetermined operative conditions.

More in particular, in an embodiment, the active material 9 is maintained suspended between the upper die 8 and the lower die 7 and at a certain distance therefrom by means of suitable suspension springs 51 suitably fixed to the lower wall 5 of the generation chamber 3 by means of arms 52. Moreover, the thin metallic layers 10 each having function of heater and temperature sensor are faced towards the active material 9, i.e., they are formed on the respective surfaces of the dies 7 and 8 faced towards the active material 9 and, i.e., in an embodiment, on the upper surface of the lower die 7 on the silicon oxide layer 7a and on the lower surface of the upper die 8 below the silicon oxide layer 8a.

In an embodiment, the lower die 7 is fixed to the lower wall 5 of the generation chamber 3, for example, by means of gluing with glues having high thermal conductivity for reducing to the minimum the transmission resistance of the thermal energy produced in the generation chamber 3 through the lower wall 5 having greater thermal conductivity. The upper die 8 is instead suspended by means of respective flexible coupling cables 15 crossing in the vertical direction the generation chamber 3 and the external chamber 4 for being coupled externally to the control module 12. Moreover, the upper die 8 is vertically mobile through suitable handling means including an arm 13 having a first portion 13a external to the reactor 2 and coupled to the top portion of the external chamber 4 and a second portion 13b vertically crossing the gap 50 between the generation chamber 3 and the external chamber 4 and coupled in a tight-sealed way to its ends on the external side of the top portion 6a of the generation chamber 3 and on the inside side of the end portion 17a of the external chamber 4. The arm 13 is, moreover, coupled by means of the first portion 13a to a motor 14 and is controlled by the latter so as to exert a predetermined compression force on the top portion 17a of the external chamber 4 and on the top portion 6a of the generation chamber 3 to which corresponds an approaching of the upper suspended die 8 towards the active material 9. The release of the compression exerted by the arm 13 controlled by the motor 14 on the internal chamber 3 and on the external chamber 4 instead causes the elastic return of the top portion 17a of the external chamber 4 and of the top portion 6a of the internal chamber in the rest position to which corresponds a distancing away of the upper die 8 from the active material 9. The compression force may be programmed so as to be variable at a predetermined interval so that the die 8 is mobile between a position of minimum distancing of the upper die 8 from the active material 9 (to which corresponds the maximum compression of the chambers 3 and 4 by the arm 13) and a position of maximum distancing away of the upper die 8 from the active material 9 (to which corresponds the absence of compression on the chambers 3 and 4 and a situation of maximum volume of confinement of active ions and thus of minimum concentration for the nuclear reactions on the surfaces of the active material 9).

In the generation chamber 3 there are, moreover:
means for the triggering of low-temperature nuclear reactions that, in this example, include a plurality of filaments 19 realized in a material suitable for impulsively realeasing electrons if heated in a suitable way (for example filaments in tungsten coated with alkaline metals), said filaments being arranged on opposite sides and at a predetermined distance from the active material 9;
a sensor 20 for the detection of ionizing radiations (such as alpha and beta rays) and/or electromagnetic radiations such as gamma rays, this for monitoring the working safety of the reactor 2 but also the entity of the nuclear reaction.

Between the generation chamber 3 and the external chamber 4 there are contemplated, moreover:
a coil 21 for generating an electromagnetic field able to favor the passage and the stationing of H-ions produced via the triggering means 19 on the surface of the active material 9,
a plurality of passing elements tight-seal coupled to the internal chamber 3 and to the external chamber 4 for the passage of electric couplings (cables) directed to the outside of the generation chamber 3 and of the external chamber 4, in particular to the control module 12, including:
a) passing elements 22 for the electric coupling of the lower die 7 towards the outside, in particular, to the control module 12,
b) passing elements 15 for the electric coupling of the upper die 8 towards the outside, in particular, to the control module 12, said passing elements being flexible to account for the vertical mobility of the upper die 8 as above described,
c) passing elements 23 for the electric coupling of the triggering means 19 towards the outside, in particular, to the control module 12,
d) passing elements 24 for the coupling of the detection sensor 20 of ionizing rays and/or electromagnetic waves towards the outside,
a tube 25 for supplying hydrogen (and/or its isotopes) or a substance able to release hydrogen inside the generation chamber 3, the supply tube 25 being coupled onto the external side of the generation chamber 3 and to the external chamber 4 so as to ensure the seal-tightness of these chambers and being moreover provided with a valve 26 for the regulation of the flow,
passing elements 27 tight-seal coupled to the external chamber 4 for the electric coupling of the coil 21 to the outside of the reactor 2 and, in particular, to the control module 12.

Turning back to the external chamber 4, it is to be said that the lower wall 16 exhibits a substantially plate-like central portion 16a realized in a high-thermal-conductivity material, for example, copper and facing the lower wall 5, having greater thermal conductivity than the generation chamber 3, and a peripheral portion 16b having a peripheal extension realized in a material having lower thermal conductivity, for example, steel.

The peripheral portion 16b is laterally coupled to the respective substantially central portion 16a of the lower wall 16, and above is the ring 18 of flexible material. Advantageously, the external chamber 4 may be coupled to second handling means 28 controlled by a motor 29 for moving the external chamber 4 with respect to said generation chamber 3, specifically the lower wall 16 between a position of maximum approachment obtained by approaching the lower wall 16 to the lower wall 5 with simultaneous compression of the flexible ring 18 up to the substantial contact of the central portion 16a of the lower wall 16 of the external chamber 4 with the lower wall 5 of the generation chamber 3 and a position of maximum distancing away between the lower part 5 of the generation chamber 3 and the lower wall 16 of the external chamber 4 with formation of a gap 50 between said walls 5 and 16 consequent to the release of the compression on the flexible ring 18.

Moreover, the external chamber 4 is provided with an opening 30 for the extraction of air inside by means of suitable, e.g., conventional, means able to apply a reduced pressure (vacuum) inside the external chamber 4 and in particular in the gap 50 between the external chamber 4 and the internal chamber 3 of energy generation. A regulation valve 31 is, moreover, contemplated at the opening 30. The execution of the vacuum in the external chamber 4 (i.e., in the gap between the external chamber 4 and the generation chamber 3) may advantageously allow one to limit to the maximum the dispersions of heat from the generation chamber 3 by convection by forcing the thermal energy (heat) produced in the generation chamber 3 to exit the reactor 2 through the lower walls 5 and 16 of the generation chamber 3 and of the external chamber 4 respectively.

For the purpose of limiting to the maximum also the possible dispersion through radiation, the external part of the inner chamber 3 maty include a suitable reflecting material, or may be made such by suitably working the material used for the realization of the internal chamber 3 so that it is reflecting (for example mirror polished steel).

A method according to an emobdiment by means of the above-described apparatus 1 first of all contemplates the disposition of an active material 9, already described, inside the generation chamber 3 between the dies 7 and 8, and the introduction through the tube 25 of hydrogen (and/or its isotopes) or of a substance able to release hydrogen (and/or its isotopes) in the gaseous or ionic form in the generation chamber 3. Hydrogen thus comes in contact with the active material 9 in the generation chamber 3.

At this point, by supplying electric energy to the heater 10, the active material 9 is heated through the Joule effect by the heaters 10 of the dies 7 and 8 that are faced towards the active material 9 until a predetermined temperature is attained or exceeded.

Normally, by supplying a predetermined amount of energy coming from an external supplier (not shown), it may be possible to bring the reactor 2 to the conditions of temperature, pressure, electric biasing, and other conditions for concentrating hydrogen and/or its isotopes on the active material 9.

In particular, the heating by means of the heater 10, according to the active material used, may facilitate the adsorption of hydrogen on the surface of the active material 9, which may be further favored by the suitable disposition of the dies 7 and 8 each containing a heater 10 and being some distance from the active material 9.

Basically, the hydrogen and/or its isotopes are stored in the crystal lattice of the metal being part of the active material 9 under conventional conditions that facilitate the formation of hydrides through interaction between hydrogen and the metal, the formation of such hydrides being deemed as fundamental for the triggering of nuclear reactions with consequent production of excess thermal energy.

When the concentration of hydrogen atoms (and/or its isotopes) inside the crystalline structure of the metal exceeds the predetermined values, which may be known, the nuclear reaction is triggered by means of the impulsive action of the triggering means 19.

In the reactor 2, excess thermal energy is thus generated due to the above nuclear reaction, and consequently, without a suitable control of this reaction, the active material 9 would continue to heat more and more, causing a fusion of the parts composing the reactor 2.

An embodiment, therefore, proposes a series of controls aimed at optimizing both the generation of thermal energy in the reactor 2 and the recovery of the same from the reactor 2 for the subsequent conversion, for example, into electrical energy.

As regards the generation of energy, first of all, as the rate of nuclear reactions increases by the effect of the absorption of hydrogen, the increase in temperature is detected by the heaters/sensors 10 integrated on the dies 7 and 8 directly and advantageously in the reaction area, i.e., near the surface of the active material 9.

The control module 12 thus receives an electrical signal relative to the measurement of the reaction temperature by the heater/sensor 10, and may act in feedback on the intensity and frequency of the pulses supplied to the reactor 2 by means of the triggering means 19 to maintain, for example, a constant reaction temperature, or to increase or decrease the amplification of the energy produced according to the application.

Moreover, the amplification of the energy produced may be further controlled by regulating the volume of gas (hydrogen and/or its isotopes) that is near or at the reaction active area (volume of reaction), i.e., by means of the control module 12, which may act in feedback also on the first handling means including the arm 13 and the associated motor 14 so as to regulate the distance of the upper die 8 from the active material 9.

Moreover, to the end of improving the efficiency of generation of the thermal energy, the control module 12 may act in feedback also on the modulation of the non-impulsive means cooperating with the triggering means for the maintenance of the nuclear reactions, said means including, for example, a coil 21 for generating a magnetic field (alternatively they could be means for generating an electric field).

As regards instead the recovery of the thermal energy produced in the reactor 2, the flow of this thermal energy to be withdrawn by the reactor 2 by means of a system of retrieval (not shown) may be suitably regulated by modulating the mutual distance between the wall portion 16a of the lower wall 16 of the external chamber 4 and the lower wall 5 of the generation chamber 3, and, thus, by modulating in consequence the gap 50 with low thermal conductivity between the central portion 16a of the lower wall 16 and the lower wall 5. The greater the volume of the gap 50, the lower the flow of thermal energy directed towards the system of external retrieval of the reactor 2 will be, and vice versa. Advantageously, the modulation of the mutual distance between the wall portion 16a of the lower wall 16 of the external chamber 4 and the lower wall 5 of the generation chamber 3, and, thus, the modulation of the gap 50, may be regulated by the control module 12, which can act on the second handling means (arm 28 and associated motor 29) of the external chamber 4 with respect to the generation chamber 3 according, for example, to the reaction temperature detected by the sensor/heater 10 and/or to the temperature detected by a suitable sensor present in the system of retrieval of the energy.

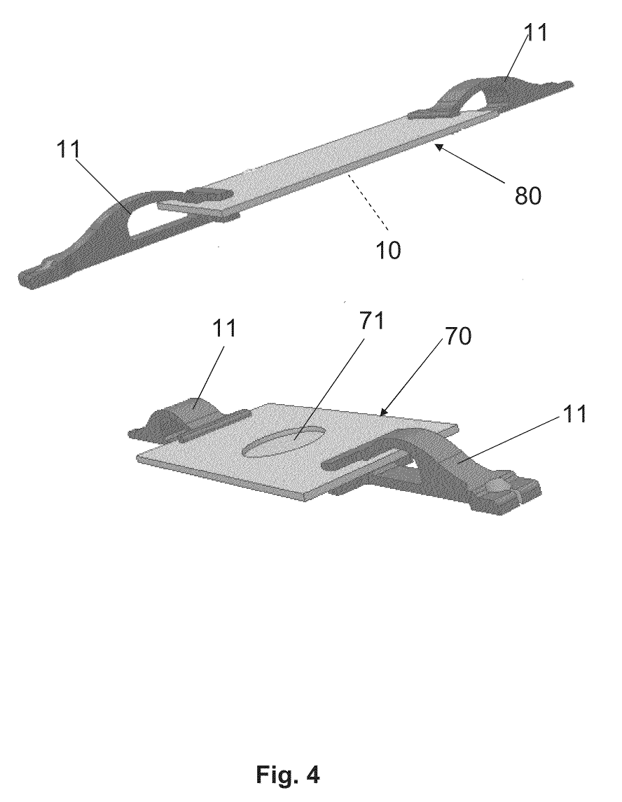

FIG. 4 shows an exploded view of a detail relating to a pair of supports (dies) each having a heater and temperature sensor realized according to another embodiment, and which may be used in the apparatus shown in FIG. 1.

In an embodiment, the active material 9 includes powders of an active metallic material as previously defined and in this case the lower die (support) 70 is provided on the side faced towards the upper die (support) 80 with an open cavity 71 wherein the powders of the active material 9 are arranged (or deposited). If the lower die 70 is realized with silicon, the cavity 71 may be coated inside with a layer of silicon oxide for insulating the active material 9 from the silicon, thus preventing possible collateral reactions between the metallic material and the silicon.

The lower die has moreover a thin surface metallic layer 10 having functions of heater/temperature sensor arranged on the surface opposite to that having the cavity 71 below a surface insulating layer of silicon oxide (not shown) if the lower die 70 is realized with silicon.

The upper die 80 exhibits, instead, substantially the same characteristics as the upper die 8 above described for the previous embodiment among which the fact of having formed on its lower surface under the layer of silicon oxide (if realized wirt silicon), a thin layer 10 of a metal having a function of heater and temperature sensor that, therefore, is advantageously faced towards the powders of the active material 9 contained in the cavity 71 of the lower die 70.

In the light of what has been described above, it is clear that an apparatus according to an embodiment finds advantageous application in the generation of energy for civil and industrial use.

Given the great difference between energy of the chemical type produced with the conventional generation apparatuses and that of the nuclear type (clearly better), with the apparatus according to an embodiment it may be possible to realize energy generators that are particularly compact, ecological, and operatively safe as they are not radioactive.

A further advantage attained by an apparatus according to an embodiment is given by the fact that the process temperature may reach, if desired, rather high levels, and thus the performance of a possible thermodynamic cycle of transformation of the heat into work may be rather high.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1-19. (canceled)

20. An apparatus, comprising:
a reaction chamber having an energy port;
a reaction unit disposed in the reaction chamber and configured to allow an energy-releasing reaction between first and second materials; and
an energy regulator configured to control a rate at which reaction-released energy exits the reaction chamber via the energy port.

21. The apparatus of claim 20 wherein the reaction chamber includes a thermally conductive wall that forms a portion of the energy port.

22. The apparatus of claim 20 wherein the reaction unit includes:
a first member configured to hold the first material; and
a material port configured to couple the reaction chamber to a source of the second material.

23. The apparatus of claim 20 wherein the reaction unit includes:
a first member configured to hold the first material; and
a reaction port configured to control a rate at which the second material enters the reaction chamber.

24. The apparatus of claim 20 wherein the reaction unit includes a mechanism configured to facilitate the reaction between the first and second materials.

25. The apparatus of claim 20 wherein the reaction unit includes a mechanism configured to generate electronic pulses that facilitate the reaction between the first and second materials.

26. The apparatus of claim 20 wherein the reaction unit includes a mechanism configured to control a rate at which the reaction releases energy.

27. The apparatus of claim 20 wherein the reaction unit includes a heater configured to heat one of the first and second materials.

28. The apparatus of claim 20 wherein the reaction unit includes a sensor configured to indicate a temperature within the reaction chamber.

29. The apparatus of claim 20 wherein the reaction unit includes a sensor configured to indicate a level of radiation within the reaction chamber.

30. The apparatus of claim 20 wherein the reaction unit includes:
a first member configured to hold the first material;
a heater configured to heat the first material; and
a mechanism configured to control a distance between the heater and the first member.

31. The apparatus of claim 20 wherein:
the energy port includes a thermally conductive wall of the reaction chamber; and
the energy regulator includes
a thermally conductive member, and
a mechanism configured to control a distance between the thermally conductive wall and the thermally conductive member.

32. The apparatus of claim 20 wherein:
the energy port includes a thermally conductive wall of the reaction chamber; and
the energy regulator includes
a thermally conductive member, and
a mechanism configured to control a pressure between the thermally conductive wall and the thermally conductive member.

33. The apparatus of claim 20 wherein:
the first material includes a solid; and
the second material includes a fluid.

34. The apparatus of claim 20 wherein:
the first material includes a transition metal; and
the second material includes hydrogen.

35. The apparatus of claim 20 wherein the reaction-released energy includes heat.

36. The apparatus of claim 20, further comprising a mechanism disposed outside of the reaction unit and configured to facilitate the reaction between the first and second materials.

37. The apparatus of claim 20, further comprising a mechanism configured to generate a magnetic field that facilitates the reaction between the first and second materials.

38. The apparatus of claim 20, further comprising:
an outer chamber in which the reaction chamber is disposed, the outer chamber including a first thermally conductive wall;
wherein the energy port includes a second thermally conductive wall that forms a portion of the reaction chamber; and
wherein the energy regulator includes a mechanism configured to control a distance between the first and second thermally conductive walls.

39. The apparatus of claim 20, further comprising:
an outer chamber in which the reaction chamber is disposed, the outer chamber including a first thermally conductive wall;
wherein the energy port includes a second thermally conductive wall that forms a portion of the reaction chamber; and
wherein the energy regulator includes a mechanism configured to control a level of a vacuum between the first and second thermally conductive walls.

40. A system, comprising:
an apparatus, including
a reaction chamber including an energy port,
a reaction unit disposed in the reaction chamber and configured to allow an energy-releasing reaction between first and second materials, and
a mechanism configured to regulate a rate at which reaction-released energy exits the reaction chamber via the energy port; and
a controller coupled to the apparatus and configured to control the mechanism.

41. The system of claim 40 wherein the controller includes an integrated circuit.

42. The system of claim 40 wherein the controller is configured to control a rate at which the reaction releases energy.

43. The system of claim 40, further comprising a converter configured to convert the reaction-released energy from the port into another form of energy.

44. The system of claim 40, further comprising:
wherein the reaction-released energy includes heat; and
a converter configured to convert the reaction-released heat from the port into electrical energy.

45. The system of claim 40 including a load configured to receive the reaction-released energy from the energy port.

46. A method, comprising:
reacting a first material with a second material within a chamber to release energy; and
controlling a rate at which the energy exits the chamber.

47-49. (canceled)

50. The method of claim 46 wherein:
one of the first and second materials includes a transition metal;
the other of the first and second materials includes hydrogen; and
the energy released by the reaction includes heat energy.

51. The method of claim 46, further comprising controlling a rate at which the reaction releases energy.

52. The method of claim 46, further comprising powering a load with the energy that exits the chamber.
